(19) United States
(12) Patent Application Publication
(10) Pub. No.: US 2016/0274871 A1
(43) Pub. Date: Sep. 22, 2016

(54) ISOLATING COMPONENTS USING METHOD DETOURING

(71) Applicant: Microsoft Technology Licensing, LLC, Redmond, WA (US)

(72) Inventors: Abhishek Ghosh, Charlottenlund (DK); Gaurav Roy, Herlev (DK)

(21) Appl. No.: 14/659,374

(22) Filed: Mar. 16, 2015

(51) Int. Cl. G06F 9/44; G06F 3/0484; G06F 3/0482

(52) U.S. Cl. CPC G06F 8/34; G06F 3/0482; G06F 3/04842

(57) ABSTRACT

A computing module that calls to another computing module is run. An isolation context is detected in the module, and all original method calls that are to be detoured are replaced with detouring method calls. The module, with the detouring method calls, is run. When a context change is detected, the module is reset with the original method calls.

### BACKGROUND

Computer systems are currently in wide use. Some such computer systems are large, monolithic computer systems that have many different components, modules or sub-modules.

In such computer systems, the different components, modules and sub-modules (referred to collectively as modules) are designed to work together. However, there may be a wide variety of different scenarios in which the individual modules may be used in isolation from one another. Many such computing systems, however, are not designed so the individual modules can work in isolation. As a result, modules in such computing systems have a relatively fixed dependence on other modules. This, often means that if a developer wishes to use only one of the modules, he/she must either redesign the system using isolation techniques to have them operate in isolation, which can be expensive; or setup all related modules, which can be time consuming and make the software slow.

The discussion above is merely provided for general background information and is not intended to be used as an aid in determining the scope of the claimed subject matter.

### SUMMARY

A computing module that calls to another computing module is run. An isolation context is detected in the calling module, and all original method calls that are to be detoured are replaced with detouring method calls. The module, with the detouring method calls, is run. When a context change is detected so the isolation context no longer exists, the module is reset with the original method calls.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram illustrating one example of method detouring.

FIG. 3 is a block diagram of one example of a module isolation system.

FIG. 4 is a flow diagram illustrating one example of the operation of the architecture shown in FIG. 1 in exposing method detouring to a developer or other user.

FIG. 5 is a flow diagram illustrating one example of the architecture shown in FIG. 1 in running a module using method detouring.

FIG. 6 is a block diagram of the architecture shown in FIG. 1 deployed in a cloud computing architecture.

FIGS. 7-9 show examples of mobile devices that can be used in the architectures shown in previous Figures.

FIG. 10 is a block diagram of a computing system environment that can be used in the architectures shown in the previous Figures.

### DETAILED DESCRIPTION

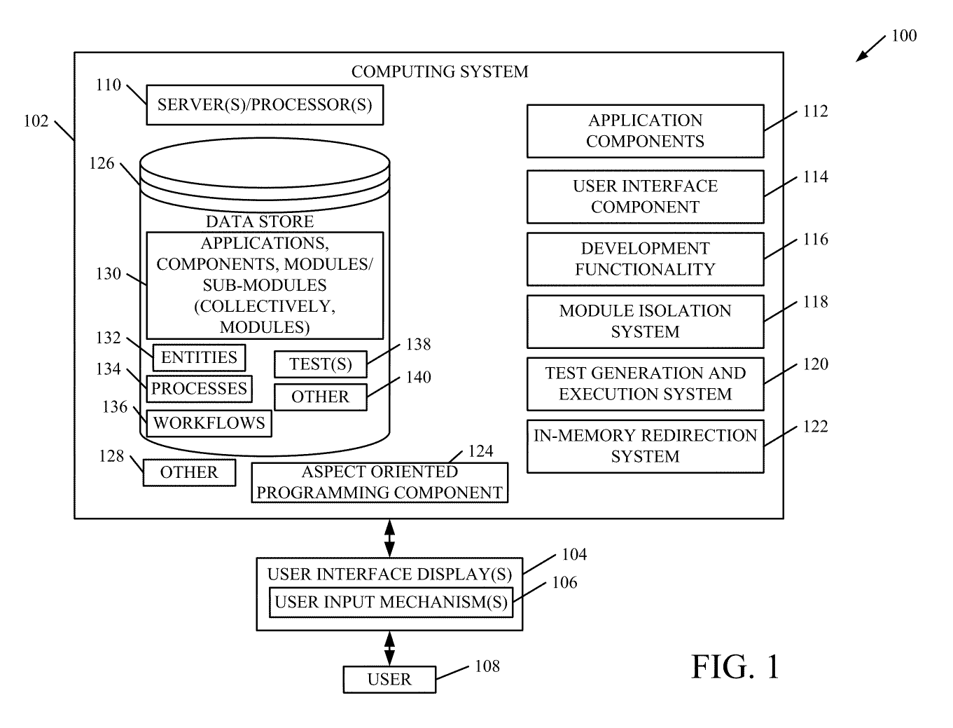

FIG. 1 is a block diagram of one example of a computing system architecture 100. Architecture 100 illustratively includes computing system 102 that is shown generating user interface displays 104, with user input mechanisms 106, for interaction by user 108. User 108, for instance, can be a developer or another user that interacts with user input mechanisms 106 in order to control and manipulate computing system 102.

In the example illustrated in FIG. 1, computing system 102 illustratively has one or more servers or processors 110, application components 112, user interface component 114, development functionality 116, module isolation system 118, test generation and execution system 120, in-memory redirection system 122, aspect oriented programming components 124, data store 126, and it can include other items 128. Data store 126, in turn, illustratively includes one or more applications, components, modules and/or sub-modules (collectively, modules) 130, entities 132, processes 134, workflows 136, tests 138, and it can include other items 140.

It will first be noted that, while the present discussion proceeds with respect to user 108 authoring modules 130 as well as other items in computing system 102 in the X++ programming language or in an intermediate language (IL) that is generated by the .NET framework, these are examples. Also, in one example, the modules and the other items run in computing system 102 can be an enterprise resource planning (ERP) system, a customer relations management (CRM) system, or a wide variety of other systems, etc. In any case, they can illustratively be relatively large, monolithic pieces of software in which the modules 130 can work together. However, because they can depend on one another, this can make it difficult to write fast and stable unit tests. This is because it often means that the user 108 that is authoring the tests normally also needs to perform a great deal of (often unrelated) data setup in order to run a test. For instance, if an inventory management module performs a method call on a method in a general ledger module, then general ledger data often needs to be setup in order to test the inventory management module. This results in tests that are difficult to write and slow to execute.

Similarly, code in many modules write to a database or a disk. Thus, it can be very difficult to write unit tests that run fast and that fail predictably only due to errors in the system under test. Further, it can be very difficult to isolate code that is invoking a user interface. Thus, it can be very difficult to write unit tests for such blocks of code (e.g., modules).

Because it is very difficult to isolate code from its environment (such as regional and language settings, time zones, system date, etc.) some tests can fail because of other, related systems. For instance, a test may be designed to validate what happens on a workday, but it may be run on a weekend. Because the code under test is dependent upon the system date, ether a separate set of system date data must be setup, or the test will fail if it is run on the weekend. Similarly, a test that validates the output in different regional settings would require changing the settings in the operating system. However, this can make other tests unstable.

In addition, testing is not the only area in which isolation of the various modules may be useful. For instance, if a database is completely replaced with an in-memory data store, this may be very fast, because relatively little information is written to disk. However, it can be very difficult to redirect all calls to the database to an in-memory location.

Before describing the operation of architecture 100 in greater detail, a brief overview of some of the items in architecture 100 will first be provided. For purposes of the present discussion, it will be assumed that user 108 is a developer. The user interface displays are generated for the developer. Application components 112 illustratively run modules 130 that can perform processes 134, workflows 136, etc. In doing so, they can operate on entities 132 or other records 140. Development functionality 116 illustratively exposes user 108 to development components that user 108 can interact with in order to develop, modify, or otherwise interact with modules 130. In addition, module isolation system 118 illustratively exposes user 108 to compose module isolation components that allow user 108 to author modules so that they can be run in isolation. This is described in greater detail below.

Test generation and execution system 120 illustratively allows user 108 to generate tests 138 and to have those tests executed on the computing system that user 108 is developing. In-memory redirection system 122 illustratively allows the modules 130 to perform in-memory operations, instead of writing to a disk. Aspect oriented programming components 124 illustratively perform aspect oriented programming functions, such as event logging, and other such functions.

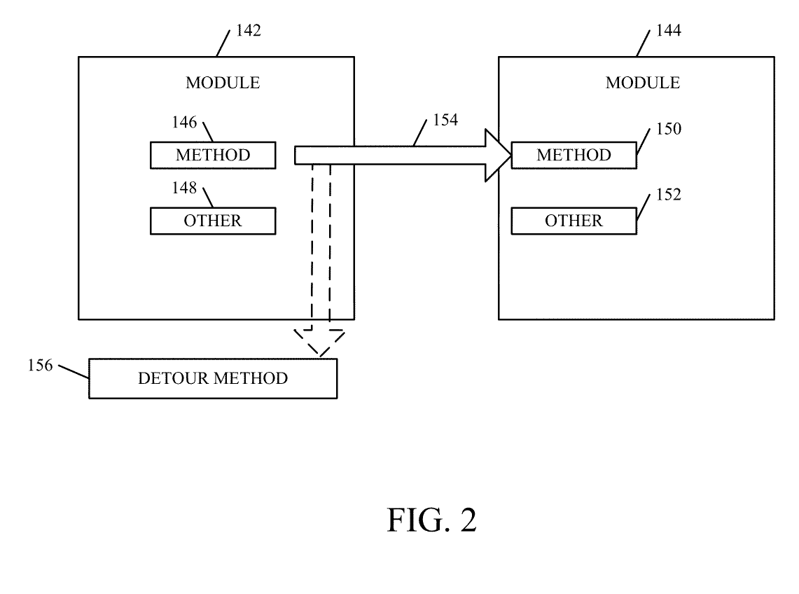

FIG. 2 is a block diagram of a set of modules 142 and 144 that illustrate method detouring. FIG. 2 shows that, in one example, module 142 illustratively includes a method 146, and it can include other items 148. Similarly, module 144 illustratively includes a method 150 and it can include other items 152. In one example, method 146 is illustratively designed to call method 150. The method call is indicated by arrow 154. However, in one example, using component isolation system 118, user 108 can configure module 142 so that, in a certain context, the method call indicated by arrow 154 is detoured from method 150, to a detour method 156 that has the same signature as method 150. However, because detour method 156 is not in module 144, module 142 is isolated from module 144. This provides significant advantages, some of which are described in greater detail below. Also, in accordance with one example, method call 154 can be detoured to a method 156 that is generated by component isolation system 108. In another example, system 108 can detour to any method, even an already existing one, so long as its signature matches the signature of the original method 150.

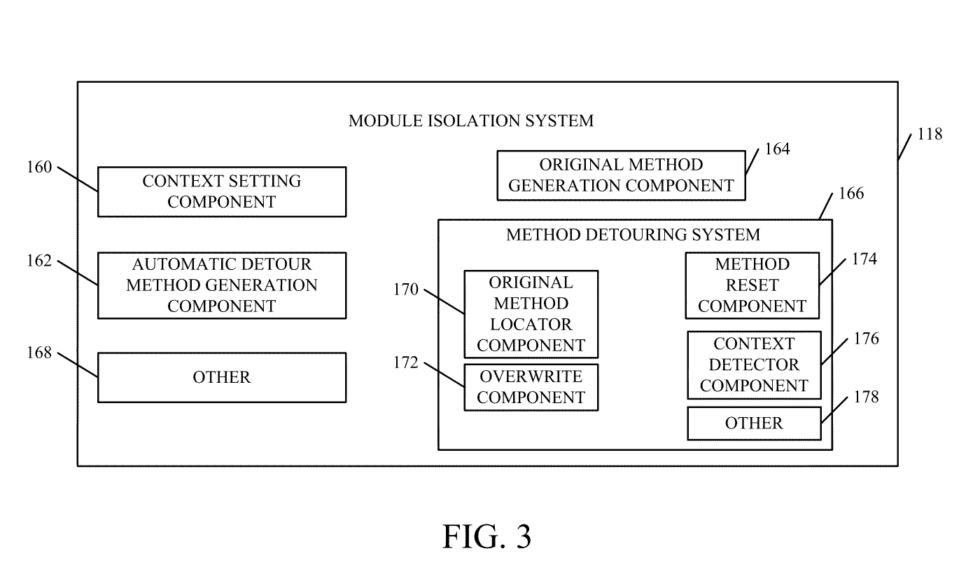

FIG. 3 is a more detailed block diagram of one example of module isolation system 118. It can be seen in FIG. 3 that module isolation system 118 can include context setting component 160, automatic detour method generation component 162, original method generation component 164, method detouring system 166, and it can include other items 168. Method detouring system 166, itself, illustratively includes original method locator component 170, overwrite component 172, method reset component 174, context detector component 176, and it can include other items 178.

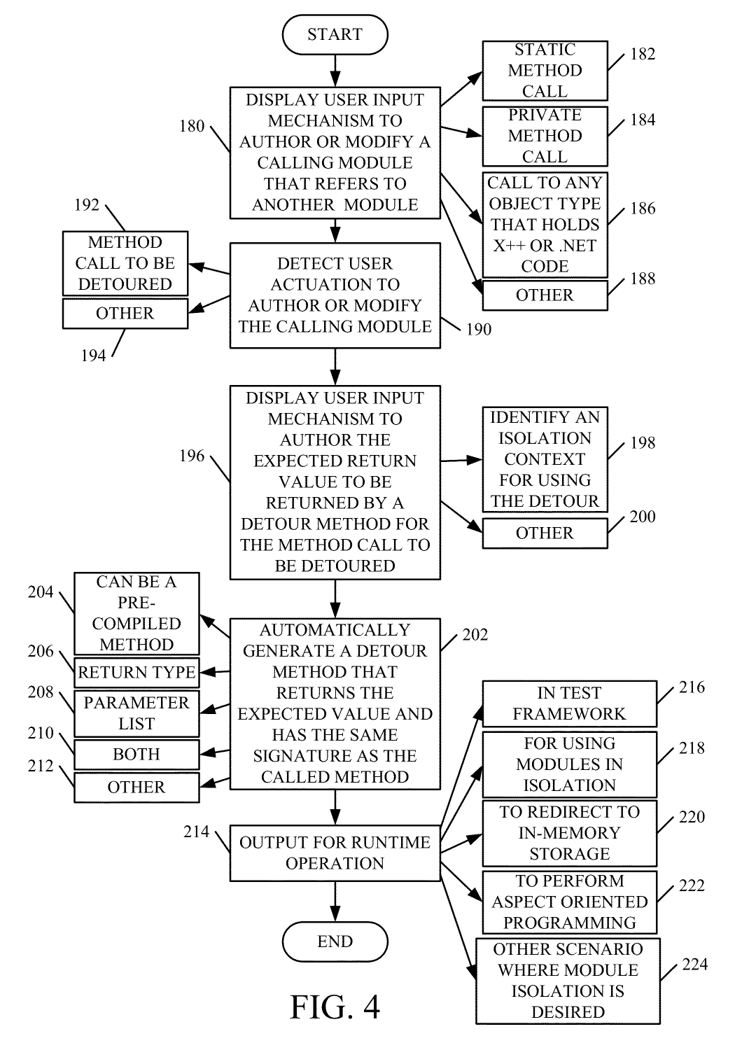

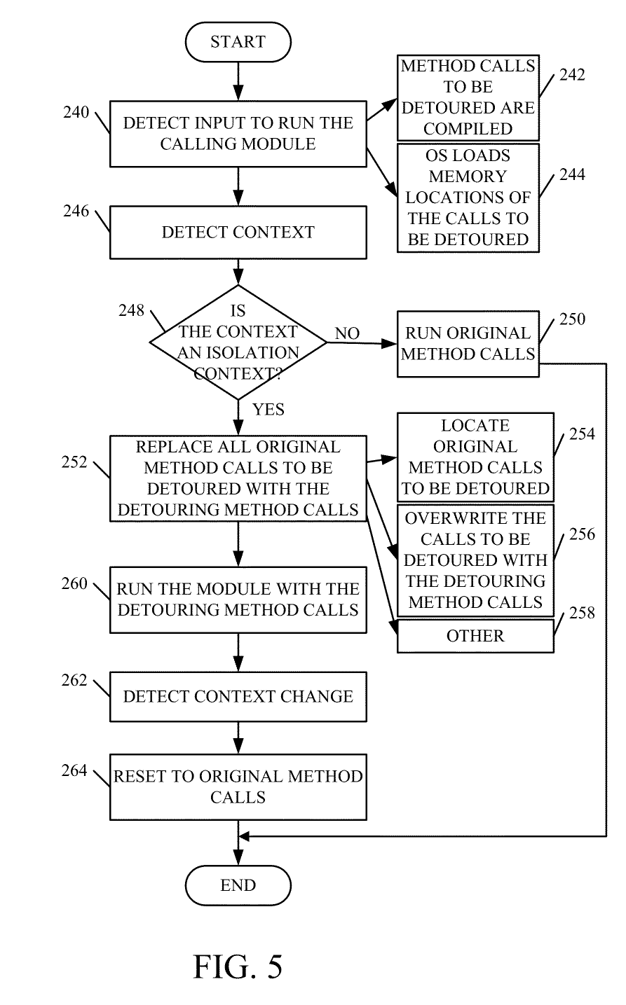

Original method generation component 164 illustratively exposes functionality that allows user (e.g., developer) 108 to author or modify an original method (such as method 146 in module 142 in FIG. 2). Context setting component 160 illustratively allows user (e.g., developer) 108 to set an isolation context in which the original method will be detoured to a detour method. For instance, it allows user 108 to set a context in which the method call 154 from method 146 is detoured to the detour method 156 (shown in FIG. 2). Automatic detour method generation component 162 can be used to receive an expected value for the detour method and to automatically generate the detour method (e.g., method 156) that has the same signature as the original method being called (e.g., method 156 is generated so it has the same signature as method 150). Method detouring system 166 can be used at runtime. Original method locator component 170 identifies the original method 146 that is making the call. Overwrite component 172 overwrites the location of the called method 150 with the location of the detour method 156 when context detector component 176 detects an isolation context. When context detector component 176 detects that the isolation context is no longer alive, then method reset component 174 resets the original calling method 146 so that it is calling the original method 150, instead of the detour method 156. This is all described in greater detail below with respect to FIGS. 4 and 5.

FIG. 4 is a flow diagram illustrating one example of the operation of module isolation system 118 in exposing user (e.g., developer) 108 to the various module isolation functions performed by the items shown in FIG. 3, in order to configure method calls so that they will be detoured so that a given module that is making the method calls can be run in isolation. Again, for purposes of the present discussion, it will be assumed that user 108 is a developer. In one example, original method generation component 164 displays a user input mechanism that allows developer 108 to author or modify a calling module (such as module 142 shown in FIG. 2). It also allows developer 108 to author the method 146 that refers to (or calls) a method in another module 144. Displaying this user input mechanism is indicated by block 180 in FIG. 4. It will be noted that, in one example, the method call made by method 146 can be a static method call 182, a private method call 184, and it can call to any object type 144 that holds X++ or .NET code as indicated by block 186. It can be displayed in other ways as well, as indicated by block 188.

Component 164 (shown in FIG. 3) then receives developer inputs (e.g., detects developer actuation of the input mechanism) in order to author the calling module 142. This is indicated by block 190. It will be noted that this can include authoring the method call from method 146, that is to be detoured. This is indicated by block 192. It can include other authoring or modifying inputs as well, as indicated by block 194. System 118 then displays a user input mechanism that can be used to author the expected return value (to be returned by a detour method 156) for the method call to be detoured. This is indicated by block 196. For instance, it can allow developer 108 to specify the expected return value that would normally be returned by method 150 in response to the method call 154 from method 146. Context setting component 160 can also detect a developer input that identifies an isolation context in which that detour will be used. This is indicated by block 198. Displaying the user input mechanism to author the expected value can be done in other ways as well, as indicated by block 200.

Automatic detour method generation component 162 then automatically generates a detour method (e.g., method 156) that returns the expected value and that has the same signature as the called method 150. This is indicated by block 202. It will be noted that, instead of automatically generating the method, the detour method can be a pre-compiled, already-existing, method 204 as well.

In order to automatically generate detour method 156 so that it has the same signature as method 150, component 162 illustratively generates detour method 156 so that it has the same return type 206 as method 150. In another example, it can be generated to have the same parameter list 208 as method 150. In yet another example, it can be automatically generated so that both the return type 206 and parameter list 208 are the same. This is indicated by block 210. It can automatically generate the detour method 156 with the same signature as method 150 in other ways as well, and this is indicated by block 212.

System 118 then outputs or stores the authored module 142 for runtime operation. This is indicated by block 214. For instance, it can be used in a test framework in test generation and execution system 120, as indicated by block 216. It can also be output for use during runtime where module 142 is run in isolation from module 144. This is indicated by block 218. It can be output for use with in-memory redirection system 122 so that the calls to a database are instead redirected to an in-memory location, as indicated by block 220. It can be output to perform aspect oriented programming with aspect oriented programming components 124. This is indicated by block 222. Of course, it can be output in a wide variety of other scenarios where it is desired to run module 142 in isolation. This is indicated by block 224. It will also be noted that running module 142 in isolation can mean not only isolating it from all other objects, but also isolating it from a subset of external objects that it refers to (e.g., calls).

FIG. 5 is a flow diagram illustrating one example of the operation of method detouring system 166, during runtime. It may first be noted that in addition to detouring to methods generated by the detour method generation component, the method detouring system can also detour to a pre-existing method, as long as that method has the same signature (e.g., input parameters and return type) as the original method. Thus, while the present discussion proceeds with respect to system 166 detouring to a method generated by the present framework, that is only one example. First, computing system 102 (shown in FIG. 1) illustratively detects an input indicating that the module 142 that has been authored by developer 108 is to be run. This is indicated by block 240 in FIG. 5. For instance, developer 108 may wish to run the module he or she just authored, in isolation. It will be assumed that, at that point, or before then, the method calls that are to be detoured (e.g., the method call 154 generated by method 146) are compiled. This is indicated by block 242. In addition, it will be assumed that the operating system of computing system 102 loads memory locations of the calls to be detoured into memory. This is indicated by block 244.

In one example, each module 142 has its own dynamic list library (or DLL). When the module 142 is written in X++, it is illustratively compiled to IL, and then to assembly code. The memory location of the method 150 to be called by method 146 is stored in the assembly code as well.

During runtime (e.g., when developer 108 wants to run the module he or she just created, in isolation), context detector component 176 illustratively detects the context in which the module 142 is being run. This is indicated by block 246. It then detects whether that context is an isolation context as indicated by block 248. If not, then the original method calls generated by method 146 are simply run, as indicated by block 150.

However, if, at block 248, context detector component 176 determines that the detected context is an isolation context, then, method detouring system 166 replaces all of the original method calls that are to be detoured (e.g., the method call 154 made by method 146 to method 150) with the detouring method calls (the method calls that call detour method 156, instead). This is indicated by block 252. In one example, original method locator component 170 locates the original method calls to be detoured in the memory that is storing the assembly code. This is indicated by block 254. Overwrite component 172 then overwrites the calls that are to be detoured with the detouring method calls (e.g., the method calls that detour the call from method 150 to method 156). This is indicated by block 256. The original method calls can be replaced by the detouring method calls in other ways as well, and this is indicated by block 258. Computing system 102 then runs the module 142 with the detouring method calls, instead of the original method calls. This is indicated by block 260.

At some point, context detector component 176 detects that the context has changed so that it is no longer an isolation context. This is indicated by block 262. At that point, method reset component 174 resets the method 146 in the memory locations to the original method calls so that they are now again configured to call method 150 instead of detour method 156. Resetting the original method calls is indicated by block 264.

A concrete example may be helpful. Assume a class, “TimeRegistration Mgt”, has a method “registerTime” that calls a static method “postToGLAccounts” in another class called “GLPostingMgt”. This may look as follows:

TABLE 1

Public static void postToGLAccounts( )
{
......
}

Now, assume that the user wishes to test “registerTime”. It will always call “postToGLAccounts”. However, the “postToGLAccounts” method may need a great deal of additional setup to run, or it may take a long time, or it may return an indeterministic result. Therefore, it may be desirable to write a unit test that, by definition, is fast and deterministic. In that case, “posttoGLAccounts” may be isolated from “timeRegistrationMgt”. Table 2 below shows one example of a detour for this method, such that the detoured method does nothing.

```
TABLE 2
using(var context = SysDetourContext::createContext( ))
{
      Context. whenMethodCalled(classstr(GLPostingMgt),
staticmethodstr(GLPostingMgt, postToGLAccounts))
        .doReturnVoid( );
          ......
    <call postToGLAccounts here directly, or call another method
that calls postToGLAccounts; all calls to postToGLAccounts will be
detoured to a method that does nothing>
}
```

In the above example, the “SysDetourContext::CreateContext( )” in the “using” statement identifies a context in which all calls to “postToGLAccounts” will be detoured to a method that does nothing.

As another example, assume that the “postToGLAccounts” method returns a Boolean value, depending on whether the posting was successful. Assume that user 108 wishes to detour to a method that does nothing, but returns a “true” indicating that the posting was successful, so that the calling program (“registerTime” in this example) can continue with its program flow. Table 3 below indicates one example of this.

```
TABLE 3
using(var context = SysDetourContext::createContext( ))
{ Context.whenMethodCalled(classstr(GLPostingMgt),
staticmethodstr(GLPostingMgt, postToGLAccounts))
    .doReturnValue(true);
    ......
        <call postToGLAccounts here directly, or call another method
that calls postToGLAccounts; all calls to postToGLAccounts will be
detoured to a method that does nothing and returns true>
}
```

It can be seen that, again, the “Using” statement creates an isolation context and that all calls to “postToGLAccounts” are detoured to a method that does nothing, but returns “true”.

In these examples, the redirection lasts as long as the isolation context lives. In the examples shown in Tables 2 and 3, that is the closing bracket in the “Using” block. After that, the system reverts to its original state. Of course, it will be appreciated that multiple detours can be done in the same context. Also, a clean restore can be done even when an unhandled exception is encountered when running the test.

It can thus be seen that the component isolation described herein can be used to increase quality, componentization, customizability, and maintainability as examples. It advantageously allows components, modules or sub-modules to be isolated from one another. This makes testing much easier to write and quicker to execute. It can be done without performing data setup to setup a called method. Also, because the code need not write to a database or disk, it can run much more quickly and fail predictably only due to errors in the system under test. Further, the code can be isolated even when it is invoking a user interface. The code can quickly and easily be isolated from its environment, such as regional and language settings, time zones, system date, etc. Therefore, tests written on the code will not fail because of the environmental systems. It can be run on static and private methods and methods which are not part of class objects.

In addition, it can be used to replace the database completely, with an in-memory data repository. It can be used by users who wish to simply use the individual components, modules or sub-modules in isolation. For example, a user may wish to use a production floor management and time registration module, without using a general ledger module. It can also be used to implement aspect-oriented programming

Similarly, the method rewriting can be of different types, such as preserving and non-preserving, and can be achieved at different levels, such as intermediate language or assembly code. While the implementation discussed above is a non-preserving assembly code rewrite, it will be appreciated that it can easily be changed as desired. It can be used for any object type that holds X++ code or .NET code, or others.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

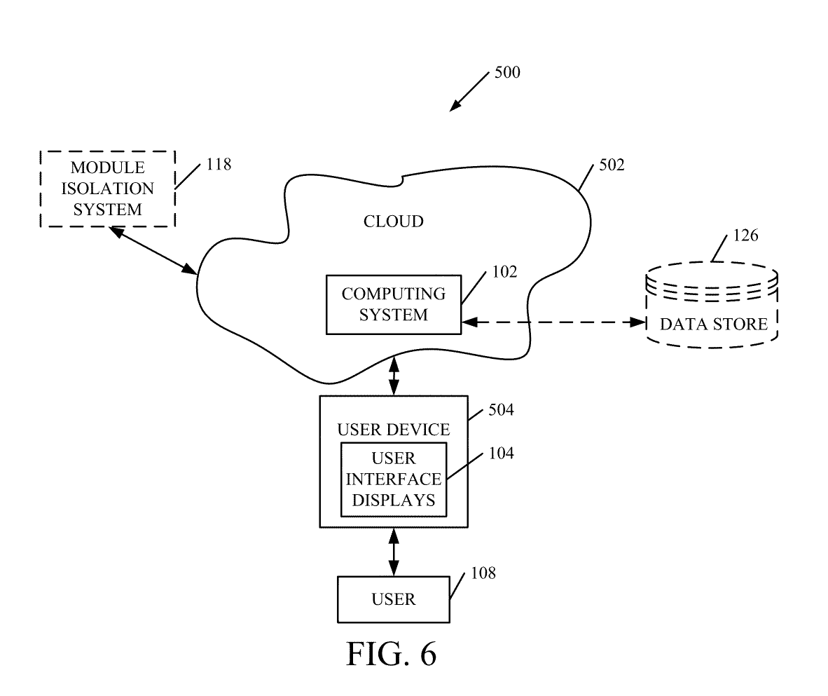

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that system 102 can be located in cloud 502 (which can be public, private, or a combination where portions are public while others are private). Therefore, user 108 uses a user device 504 to access those systems through cloud 502.

FIG. 6 also depicts another example of a cloud architecture. FIG. 6 shows that it is also contemplated that some elements of system 102 can be disposed in cloud 502 while others are not. By way of example, data store 126 can be disposed outside of cloud 502, and accessed through cloud 502. In another example, module isolation system 118 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

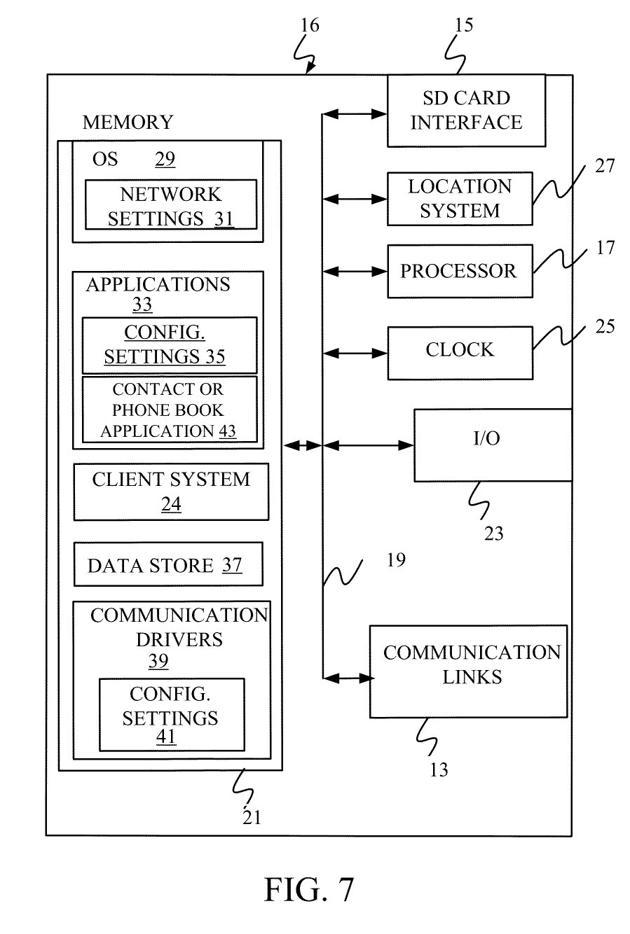

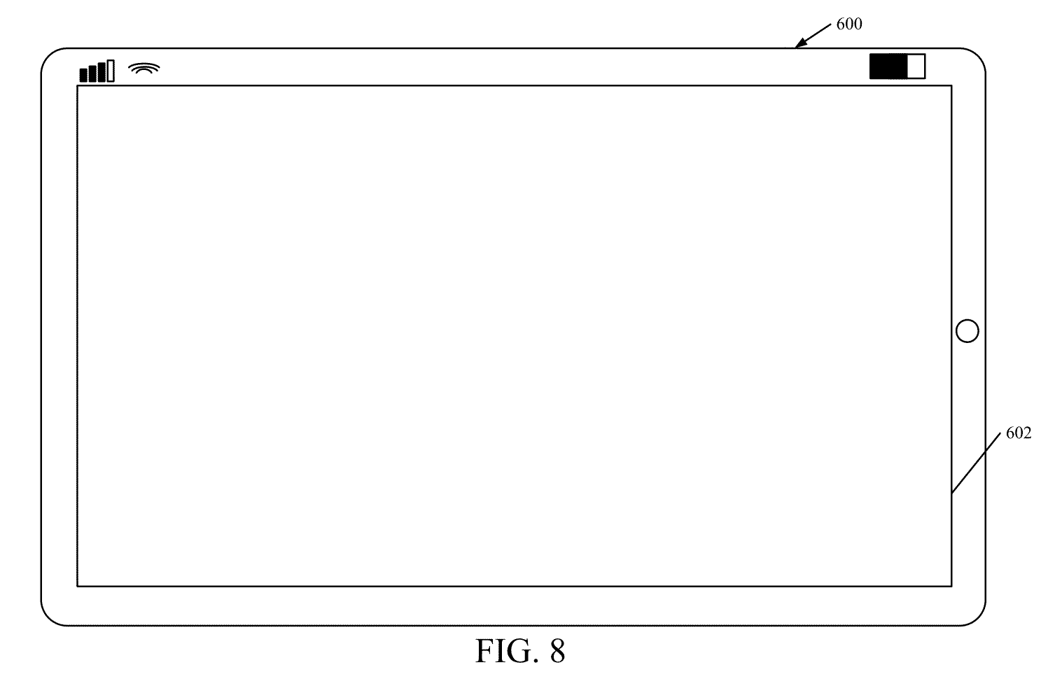

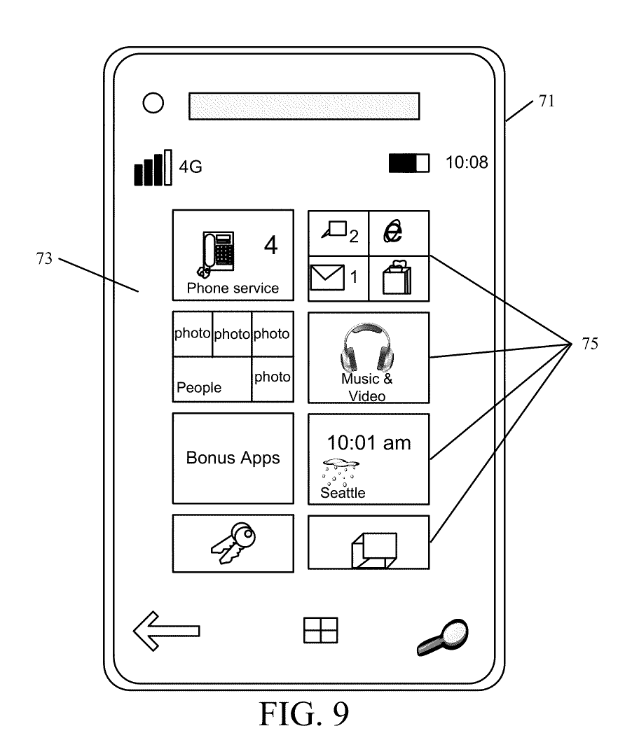

FIG. 7 is a simplified block diagram of one illustrative embodiment of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of system 102 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors or servers 110 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. The device can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some examples, the phone can also include a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 9 shows that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

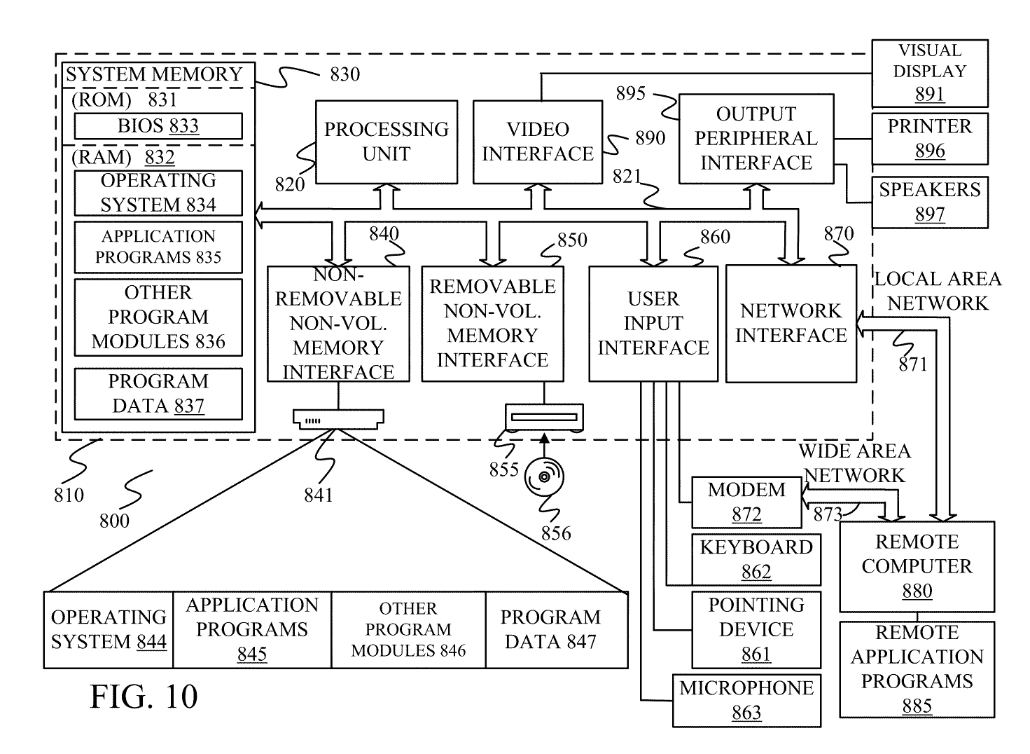

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 110), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a method generation component that displays user interface displays with method generation user input mechanisms and detects user interaction with the method generation user input mechanisms to generate a first module that has a first method with a first method call that calls a second method in a second module;

a context setting component that displays a context setting user input mechanism and detects user interaction with the context setting user input mechanism to set an isolation context for the first method in the first module, the isolation context indicating that the first method call is to be redirected to a detour method by a detour method call; and

an automatic detour method generation component that displays a detour method generation user input mechanism and detects user interaction with the detour method generation user input mechanism to receive an expected value user input identifying an expected value to be returned by the second method in the second module and, in response to receiving the expected value, automatically generates a detour method that returns the expected value.

Example 2 is the computing system of any or all previous examples wherein the second method has a signature and wherein the automatic detour method generation component generates the detour method to have a same signature as the second method.

Example 3 is the computing system of any or all previous examples wherein the automatic detour method generation component generates the detour method to have a same return type as the second method.

Example 4 is the computing system of any or all previous examples wherein the automatic detour method generation component generates the detour method to have a same parameter list as the second method.

Example 5 is the computing system of any or all previous examples wherein the automatic detour method generation component generates the detour method to have a same return type and parameter list as the second method.

Example 6 is the computing system of any or all previous examples wherein the first and second modules are part of an enterprise resource planning system or a customer relations management system.

Example 7 is the computing system of any or all previous examples wherein the first and second modules have code written in X++ or intermediate language generated from X++.

Example 8 is the computing system of any or all previous examples and further comprising:

an application component that detects a run user input and, in response, runs the first module.

Example 9 is the computing system of any or all previous examples and further comprising:

a method detouring system that detects the isolation context in the running first module and, in response, replaces the first method call with the detour method call.

Example 10 is the computing system of any or all previous examples wherein an operating system in the computing system loads a compiled version of the first module into memory, and wherein the method detouring system comprises:

an original method locator component that locates the first method in the memory;

a context detector component that detects the isolation context; and

an overwrite component that overwrites the first method call in the memory with the detour method call in response to the context detector component detecting the isolation context.

Example 11 is the computing system of any or all previous examples wherein the method detouring system further comprises:

a method reset component that resets the first method call in the memory in response to the context detector component detecting that the isolation context is no longer alive in the running first module.

Example 12 is a computer implemented method, comprising:

controlling a user interface component to display user interface displays with method generation user input mechanisms;

detecting user interaction with the method generation user input mechanisms to generate a first module that has a first method with a first method call that calls a second method in a second module;

controlling the user interface component to display a context setting user input mechanism;

detecting user interaction with the context setting user input mechanism to set an isolation context for the first method in the first module, the isolation context indicating that the first method call is to be redirected to a detour method by a detour method call; and

controlling the user input mechanism to display a detour method generation user input mechanism;

detecting user interaction with the detour method generation user input mechanism to receive an expected value user input identifying an expected value to be returned by the second method in the second module; and

in response to receiving the expected value, automatically generating a detour method that returns the expected value.

Example 13 is the computer implemented method of any or all previous examples wherein the second method has a signature and wherein automatically generating the detour method comprises:

generating the detour method to have a same signature as the second method.

Example 14 is the computing system of any or all previous examples wherein generating the detour method to have a same signature as the second method comprises one of:

generating the detour method to have a same return type as the second method;

generating the detour method to have a same parameter list as the second method; and

generating the detour method to have a same return type and parameter list as the second method.

Example 15 is the computer implemented method of any or all previous examples and further comprising:

detecting a run user input; and

in response, running the first module.

Example 16 is the computer implemented method of any or all previous examples wherein running the first module comprises:

detecting the isolation context in the running first module; and

in response, replacing the first method call with the detour method call.

Example 17 is the computer implemented method of claim 16 wherein running the first module comprises:

loading a compiled version of the first module into memory;

locating the first method in the memory; and

in response to detecting the isolation context, overwriting the first method call in the memory with the detour method call.

Example 18 is the computer implemented method of any or all previous examples wherein running the first module further comprises:

resetting the first method call in the memory in response to detecting that the isolation context is no longer alive in the running first module.

Example 19 is a computing system, comprising:

an application component that detects a run user input and, in response, runs a first module that has a first method with a first method call that calls a second method in a second module; and

a method detouring system that detects an isolation context in the running first module, the isolation context indicating that the first method call is to be redirected to a detour method by a detour method call and, in response, replaces the first method call in the first method with the detour method call.

Example 20 is the computing system of any or all previous examples wherein an operating system in the computing system loads a compiled version of the first module into memory, and wherein the method detouring system comprises:

an original method locator component that locates the first method in the memory;

a context detector component that detects the isolation context;

an overwrite component that overwrites the first method call in the memory with the detour method call in response to the context detector component detecting the isolation context; and

a method reset component that resets the first method call in the memory in response to the context detector component detecting that the isolation context is no longer alive in the running first module.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a method generation component that displays user interface displays with method generation user input mechanisms and detects user interaction with the method generation user input mechanisms to generate a first module that has a first method with a first method call that calls a second method in a second module;
a context setting component that displays a context setting developer input mechanism and detects developer interaction with the context setting developer input mechanism to set an isolation context for the first method in the first module, the isolation context indicating that the first method call is to be redirected to a detour method by a detour method call; and
an automatic detour method generation component that displays a detour method generation developer input mechanism and detects developer interaction with the detour method generation developer input mechanism to receive an expected value developer input identifying an expected value to be returned by the second method in the second module and, in response to receiving the expected value, automatically generates a detour method that returns the expected value.

2. The computing system of claim 1 wherein the second method has a signature and wherein the automatic detour method generation component generates the detour method to have a same signature as the second method.

3. The computing system of claim 2 wherein the automatic detour method generation component generates the detour method to have a same return type as the second method.

4. The computing system of claim 2 wherein the automatic detour method generation component generates the detour method to have a same parameter list as the second method.

5. The computing system of claim 2 wherein the automatic detour method generation component generates the detour method to have a same return type and parameter list as the second method.

6. The computing system of claim 1 wherein the first and second modules are part of an enterprise resource planning system or a customer relations management system.

7. The computing system of claim 6 wherein the first and second modules have code written in X++ or intermediate language generated from X++.

8. The computing system of claim 1 and further comprising:
an application component that detects a run developer input and, in response, runs the first module.

9. The computing system of claim 8 and further comprising:
a method detouring system that detects the isolation context in the running first module and, in response, replaces the first method call with the detour method call.

10. The computing system of claim 9 wherein an operating system in the computing system loads a compiled version of the first module into memory, and wherein the method detouring system comprises:
an original method locator component that locates the first method in the memory;
a context detector component that detects the isolation context; and
an overwrite component that overwrites the first method call in the memory with the detour method call in response to the context detector component detecting the isolation context.

11. The computing system of claim 10 wherein the method detouring system further comprises:
a method reset component that resets the first method call in the memory in response to the context detector component detecting that the isolation context is no longer alive in the running first module.

12. A computer implemented method, comprising:
controlling a user interface component to display developer interface displays with method generation developer input mechanisms;
detecting developer interaction with the method generation developer input mechanisms to generate a first module that has a first method with a first method call that calls a second method in a second module;
controlling the user interface component to display a context setting developer input mechanism;
detecting developer interaction with the context setting developer input mechanism to set an isolation context for the first method in the first module, the isolation context indicating that the first method call is to be redirected to a detour method by a detour method call; and
controlling the user interface component to display a detour method generation developer input mechanism;
detecting developer interaction with the detour method generation developer input mechanism to receive an expected value developer input identifying an expected value to be returned by the second method in the second module; and
in response to receiving the expected value, automatically generating a detour method that returns the expected value.

13. The computer implemented method of claim 12 wherein the second method has a signature and wherein automatically generating the detour method comprises:
generating the detour method to have a same signature as the second method.

14. The computing system of claim 13 wherein generating the detour method to have a same signature as the second method comprises one of:
generating the detour method to have a same return type as the second method;
generating the detour method to have a same parameter list as the second method; and
generating the detour method to have a same return type and parameter list as the second method.

15. The computer implemented method of claim 12 and further comprising:
detecting a run developer input; and
in response, running the first module.

16. The computer implemented method of claim 15 wherein running the first module comprises:
detecting the isolation context in the running first module; and
in response, replacing the first method call with the detour method call.

17. The computer implemented method of claim 16 wherein running the first module comprises:
loading a compiled version of the first module into memory;
locating the first method in the memory; and
in response to detecting the isolation context, overwriting the first method call in the memory with the detour method call.

18. The computer implemented method of claim 17 wherein running the first module further comprises:
resetting the first method call in the memory in response to detecting that the isolation context is no longer alive in the running first module.

19. A computing system, comprising:
an application component that detects a run developer input and, in response, runs a first module that has a first method with a first method call that calls a second method in a second module; and
a method detouring system that detects an isolation context in the running first module, the isolation context indicating that the first method call is to be redirected to a detour method by a detour method call and, in response, replaces the first method call in the first method with the detour method call.

20. The computing system of claim 19 wherein an operating system in the computing system loads a compiled version of the first module into memory, and wherein the method detouring system comprises:
an original method locator component that locates the first method in the memory;
a context detector component that detects the isolation context;
an overwrite component that overwrites the first method call in the memory with the detour method call in response to the context detector component detecting the isolation context; and
a method reset component that resets the first method call in the memory in response to the context detector component detecting that the isolation context is no longer alive in the running first module.
